(19) United States
(12) Patent Application Publication
(10) Pub. No.: US 2008/0011378 A1
(43) Pub. Date: Jan. 17, 2008

(54) Sanitary Hose Produced from Flexible Plastic, Having an Antibacterial Finish

(76) Inventors: Andreas Fath, Haslach (DE); Zafer Akaltan, Schiltach (DE); Werner Heinzelmann, Alpirsbach (DE); Jan Heisterhagen, Schutterwald (DE); Martin Surm, Schramberg (DE)

Correspondence Address: DUANE MORRIS, LLP;IP DEPARTMENT, 30 SOUTH 17TH STREET, PHILADELPHIA, PA, 19103-4196, US

(21) Appl. No.: 11/570,702

(22) PCT Filed: Jun. 23, 2005
(86) PCT No.: PCT/EP05/06803

§ 371 Date: Jul. 20, 2007

(30) Foreign Application Priority Data
Jun. 23, 2004 (DE) 102004031923.5

(51) Int. Cl. F16L 11/12

(52) U.S. Cl. 138/137

(57) ABSTRACT

The invention relates to a sanitary hose produced from flexible plastic, especially a shower hose, comprising an inner surface 17 and an outer surface 14 and having an antimicrobial finish. For the antimicrobial finish, at least one antimicrobial plastic is embedded in the material at least of the inner surface 17.

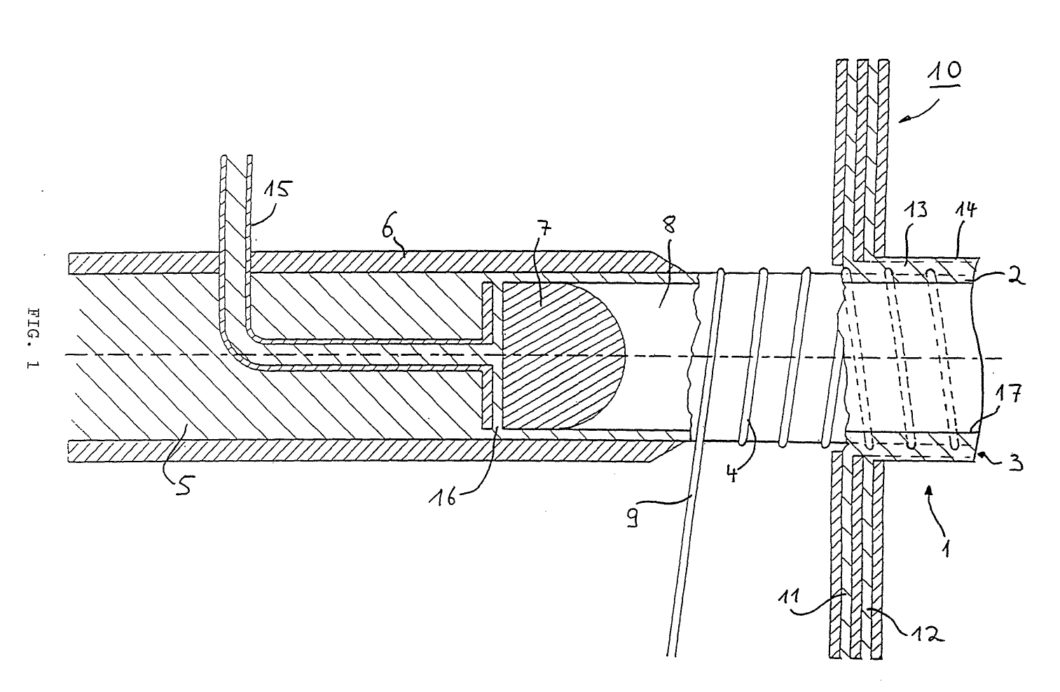

The invention relates to a sanitary hose produced from flexible plastic, especially a shower hose, comprising an inner surface and an outer surface and having an antibacterial finish.

Microbial impurities in the drinking and service water constitute, not only in the developing nations, a serious health risk. In the industrialized nations, too, life-threatening microbial impurities are appearing with increasing frequency in drinking or service water containers or pipes or water heaters. In pipes, containers or extraction devices in which the originally low-contamination water stands, is heated or is transported for a certain period are particularly affected by such contaminations.

These microbial impurities are produced by the residence of the water in containers or pipe sections at ambient temperatures which is extremely favorable to the multiplication of microorganisms. At particular risk are water heaters or hot water pipes through which hot water initially flows, yet, following the water extraction, the remaining residual water slowly cools and, in so doing, traverses over a relatively long period the optimal temperature range for the multiplication of the microorganism. This results in a strong multiplication of these pathogenic microorganisms and the limit values, defined for drinking water, for pathogens contained in the water are very rapidly exceeded and concentrations are reached which are toxic to humans. One of the most dangerous pathogens should be regarded the Legionella (Legionella pneumophila), which have an optimal temperature range for multiplication ranging from 30° C. to 50° C.

It is currently known to protect effectively from contamination the water in water tanks and canisters in which the water is lengthily stored by the admixture of chemicals in the form of silver-containing or chlorine-containing additives. This method is practicable only in water containers, however, though not in water pipes or hoses, since a pipe through which water repeatedly flows would require a constant admixture of an antimicrobial additive of this type.

In addition to hot water containers which maintain a water temperature ranging from 30° C. to 50° C. over a lengthy period, air conditioning systems, air humidifiers, shower sprinklers and shower hoses, in which the water is exposed to ambient temperatures, especially in summer and in bathrooms, from 25° C. to 30° C., are also especially at risk. In these apparatuses and devices, a strong multiplication of the pathogens can therefore come about even with a relatively short standing time, i.e., for example, where there is an irregular extraction of the water, which pathogens, when the devices and apparatuses are started up, make their way as aerosols into the respiratory air and thus directly into the lungs. By this infection route, extremely serious to fatal infections sometimes occur, especially in the case of Legionella.

From DE 42 26 810 C1, plastic parts are known which cannot be colonized by germs and are principally used in the medical field. The bactericidal effect is achieved by silver compounds on and/or in the surface of the plastic itself. For this, the plastic is treated with a swelling agent and the swollen plastic is treated with a solution of a silver compound (for example AgNO₃). One problem consists in the fact that the silver compound, because of its water solubility, can be rapidly washed out of the material to be protected. This is a serious drawback, especially in the case of pipes which carry a heavy flow. Moreover, with long-term usage of hoses or shower sprinklers which have been coated in this way, washed-out silver nitrate can give rise to undesirable local black discolorations upon contact with the skin.

From DE 44 36 927 C2, an oral irrigator is known in which parts of a liquid container or of pump chambers are coated with a silver alloy in order to prevent contamination of the residual water remaining in the liquid container or pump.

From DE 101 34 468 A1, a rod-shaped insert of silver and special steel is known, which is introduced into an existing shower hose and, through the release of silver ions, is intended to pre-vent the growth of microorganisms in the hose. A drawback with this rod-shaped insert, in addition to the large quantity of silver, is, above all, the impairment of the flexibility of the hose by the insert and, in particular, the diminution of the hose cross section. This results in a reduction in the water flow rate. In addition, the danger exists of deposits on the coiled, rod-shaped insert, with the risk of blockage of the hose.

Silver is known as a highly toxic metal with respect to microorganisms and possesses an extremely broad antimicrobial spectrum. Its effectiveness with respect to pathogenic microorganisms results from an encroachment of the silver ions into the transmembrane energy metabolism and acts, inter alia, against both gram-negative and gram-positive bacteria, as well as various other microorganisms which are toxic to humans, especially against Legionella.

It is further known to vapor-coat products produced from various materials with a fine layer of metallic silver by means of a plasma-aided coating process in a vacuum apparatus. This coating requires, however, a very high apparative complexity and is therefore very expensive and is principally used in connection with medical engineering products.

The object of the invention is to provide a sanitary hose in which the residual water remaining after the water extraction is not contaminated by pathogenic microorganisms, even after intervals of several days between the individual water extractions.

This object is achieved by a sanitary hose produced from flexible plastic, especially a shower hose comprising an inner surface and an outer surface and having an antimicrobial finish, wherein at least one antimicrobial agent is embedded in the material at least of the inner surface.

According to the invention, the at least one antimicrobial agent is embedded in the hose material. Such an embedment does not obstruct the flow of water through the sanitary hose and can also be realized cheaply during manufacture of the hose. The antimicrobial agent can then exude or diffuse from the material of the hose surface and thus display its efficacity.

In a preferred embodiment of the invention, the antimicrobial agent is embedded not only in the material forming the hose inner side, but also in the material forming the hose outer side, i.e. the outer surface. In this way, it is also possible to prevent contaminations of the hose outer side, which may otherwise easily arise if dirt or soap residues adhere to the hose outer side. In terms of its structure, the hose can be a conventional shower hose. Preferably, the hose is an at least double-walled hose, generally a double-walled hose.

The plastic of the hose material can be fully provided with antimicrobial agent, i.e. the agent can be incorporated throughout the material. This is not necessary, however, nor in many cases is it desirable. In a preferred embodiment, the at least one antimicrobial agent is embedded in the material of the hose only in the region of the at least one surface. This ensures that the hose material retains its desired material properties, moreover, exactly as before. Furthermore, a fraction of the quantity of agent suffices without impairing the effect.

The antimicrobial agent can be variously introduced into the surface material of the hose, a variety of techniques being able to be combined. In one embodiment of the invention, for instance, the antimicrobial agent can be shot into the plastic surface. For this, in particular for the outer surface, so-called cold-gas injection is suitable. In this, particles of the antimicrobial agent, especially in the form of metal particles, are shot into the plastic surface with nitrogen under high pressure, for example, of 35 bar. The depth of penetration of the particles which is herein obtained is sufficient to obtain a long-term effect of the bacterial agent over a matter of years.

In one embodiment of the invention, the inner and/or outer surface is/are formed by a surface layer containing the antimicrobial agent. Such a surface layer preferably consists of the same plastic as an underlying layer of the hose. The flexible plastic of the hose is advantageously a flexible thermoplastic and/or a thermoplastic elastomer. Such plastics are known and include, for example, soft PVC (soft polyvinyl chloride), soft polyethylene, flexible polyurethane and silicone.

The surface layer can be a separate layer. Advantageously, it differs from the underlying hose material only by the fact that it additionally contains the antimicrobial agent. In one embodiment of the invention, the at least one surface layer is formed by a thermoplastic plastic, which is preferably extruded onto an underlying layer of the hose. Preferably, the surface layer is connected to the underlying layer. In this case, it is especially preferable if the surface layer is connected to the underlying layer by coextrusion. As a result of joint extrusion from the melt, an intimate connection of the materials takes place, with no apparent separating boundary.

The antimicrobial agent can be present in the material of the surface in a concentration which decreases from the surface inwards. This can be the case, for example, when particles of the antimicrobial agent are shot into the surface. On the other hand, the antimicrobial agent can also be distributed evenly in the surface layer. This is preferably the case when the surface layer is formed by being extrusion coated. For this, the surface layer can be formed by a material into whose melt the antimicrobial agent has been mixed.

The layer thickness of the surface layer is small in relation to the layer thickness of the rest of the hose material. It lies generally below 20%, especially below 10% of the thickness of the hose material. The layer thickness of the surface layer preferably amounts to 0.05 to 1 mm, especially 0.2 to 0.5 mm.

As already mentioned, the at least one antibacterial agent is preferably present in particle form. The particle size preferably lies within the range from 5 μm to 200 μm, especially 20 μm to 100 μm. The particle size can preferably be matched to the dissolution rate and diffusion rate of the antimicrobial agent.

As the antimicrobial agents, non-specifically acting substances preferably enter into consideration. Such agents have a very broad spectrum of activity without risk of a resistance formation. It is also possible to use agents, the after-products of which exhibit the actual effect. The agents diffuse slowly out of the plastic of the surface or are slowly washed out of said plastic, whereupon they start to take effect, which is especially desirable when the water stands for a lengthy period in the hose.

In one embodiment of the invention, the antimicrobial agent is a metal and/or a metal salt. As the metal, heavy metals such as copper, and especially silver, preferably enter into consideration. The oxidation products of copper and silver have the actual antimicrobial effect. The oxidation products are formed from the metallic form. It is also possible to directly use salts or other compounds or complexes of heavy metals, for example, in a silicate matrix, if necessary in combination with the metallic form in the form of particles. As the antimicrobial agents, non-specific organic antimicrobial agents can also be used. Such agents are known. Good antimicrobial properties are exhibited, for example, by Triclosan and PHMB. Mixtures of various antimicrobial agents can also be used, or different agents on the inner surface and the outer surface of the hose.

The concentration of agent in the surface, especially in the surface layer of the hose, can be matched to the activity and retention time of the agent. Generally, the agent is present in the material of the surface in a concentration ranging from 0.01 to 10% by weight, in particular 0.1 to 2% by weight.

The sanitary hose generally possesses at its ends connections for fitting. For instance, a shower hose is generally provided at its ends with hose nipples, by which it can be connected, on the one hand, to a hand shower and, on the other hand, to a water supply pipe. The hose according to the invention is preferably non-transparent or impermeable to light. An undesirable algae formation in the hose can thereby be prevented, so that the effect of the antimicrobial agent is fully available for the destruction of any harmful germs.

Further advantages and features of the invention derive from the following description of preferred embodiments, in conjunction with the subclaims and the drawing. The individual features can here be realized respectively in isolation or in plurality in combination with one another in respect of an embodiment.

In that embodiment of the invention which is represented in the drawing, an example of the manufacture of a hose according to the invention is represented schematically. This concerns a continuous production of a shower hose. From the continuous hose, shower hoses of a desired length are then cut to size and the hose ends are provided in the usual manner with connection nipples, whereafter the hoses are ready for use. The hose according to the invention is constituted by a double-walled shower hose 1 having an inner tube 2 of dark-hued soft PVC, an outer tube 3 of transparent soft PVC, and an intervening reinforcing coil 4 of hard PVC, which on its outer side can be aluminized or provided with an aluminum foil so as to acquire a metallic appearance.

The shower hose is produced in principle according to traditional methods by an extruder, in the present case a special finish having been carried out. An extruder screw or a pair of screws (not represented) drives the molten mass 5, from which the inner tube 2 is intended to be formed, through a ring nozzle 6, within which a mandrel 7 is present by which the hose cavity 8 is formed. In the cavity 8, an elevated internal pressure is maintained in order to prevent the hose from collapsing. A reinforcing band 9 is wound onto the still warm inner tube 2 with the formation of the reinforcing coil 4, whereafter, by virtue of a second, annular extrusion nozzle 10 configured as a coextrusion nozzle, the outer tube 3 is formed over the reinforcing coil 4, to which it easily adheres.

The coextrusion nozzle 10 is charged by separate extruders with two different melts of soft PVC, to be precise with a normal PVC melt in the ring duct 11 and a melt doped with an antimicrobial agent in the ring duct 12. Accordingly, in the present embodiment, the outer tube 3 of the shower hose according to the invention is of twin-layered configuration. The melt entering through the ring duct 11 forms the bottom layer 13 of the outer tube 3, which layer comes to bear upon the reinforcing coil 4. The top layer 14, forming the outer surface of the hose, is substantially thinner than the bottom layer 13, but, as a consequence of the coextrusion, is fixedly connected to the bottom layer, the same base material being used.

The melt of the top layer or surface layer 14 is formed from a PVC granulate, in which silver particles are embedded in a quantity of 1% by weight. The silver particles have a mean size in the range from 50 to 100 μm. The top layer or surface layer formed from this melt has a layer thickness in the region of 0.3 mm.

For the configuration of the inner tube 2, a granulate can be used in which the antimicrobial agent is already contained. In such a case, antimicrobial agents in the form of non-specifically acting organic compounds such as Triclosan® (2,4,4′trichloro-2′-hydroxydiphenyl)ether) or PHMB (polyhexamethylene biguanide) hydrochloride) are suitable.

By contrast, in the represented embodiment, an embodiment of the antimicrobial agent in the inner surface of the inner tube takes place as long as this is preformed yet is still present in the form of the melt 5. A metering pipe 15 emanating from outside the extruder leads into the mandrel 7 and through a multiplicity of radial single nozzles 16 onto the outer face of the mandrel 7. Through pressurization, antimicrobial agent in powder form or in paste form can exude through the radial nozzles 16 and is there swept off and absorbed by the passing melt, in particular, fused into this, with the formation of the inner surface 17. The antimicrobial agent can also already be present in the form of a melt, by being previously mixed, for example, with PVC powder and fused on in this. As the antimicrobial agent, silver in particle form is here once again suitable. The silver can be present both in metallic form and in the form of a salt or complex having sufficient solubility to achieve a good bactericidal effect from the outset, if so desired. The radial nozzles 16 can also be combined, if required, into a radial ring nozzle. This is advantageous when the entire inner surface of the inner tube is intended to be provided with antimicrobial agent.

1. A sanitary hose including flexible plastic material, the sanitary hose comprising an inner surface and an outer surface and having an antimicrobial finish, wherein at least one antimicrobial agent is embedded in the material at least at the inner surface.

2. The sanitary hose as claimed in claim 1, further comprising at least one said antimicrobial agent embedded in the material at the outer surface.

3. The sanitary hose as claimed in claim 1, wherein the hose is at least double-walled.

4. The sanitary hose as claimed in claim 1, wherein the antimicrobial agent is embedded in the material of the hose only in a region of the at least one surface.

5. The sanitary hose as claimed in claim 1, wherein the antimicrobial agent is shot into the surface, such that the antimicrobial agent has a concentration that varies from the surface inwards.

6. The sanitary hose as claimed in claim 1, wherein at least one of the inner and outer surfaces is formed by a surface layer comprising the antimicrobial agent.

7. The sanitary hose as claimed in claim 6, the surface layer comprises a same plastic as comprised by an underlying layer of the hose.

8. The sanitary hose as claimed in claim 1, wherein the flexible plastic material comprises at least one of a flexible thermoplastic and a thermoplastic elastomer.

9. The sanitary hose as claimed in claim 6, wherein the surface layer comprises a thermoplastic plastic extruded onto an underlying layer of the hose.

10. The sanitary hose as claimed in claim 6, wherein the surface layer is connected to an underlying layer of the hose.

11. The sanitary hose as claimed in claim 6, wherein the surface layer is connected to an underlying layer of the hose by coextrusion.

12. The sanitary hose as claimed claim 1, wherein the at least one antimicrobial agent is present in a concentration which decreases from a surface of the hose inwards.

13. The sanitary hose as claimed in claim 6, wherein the antimicrobial agent is fused into components of the plastic material forming a surface layer.

14. The sanitary hose as claimed in claim 6, wherein the surface layer has a layer thickness of 0.05 to 1 mm.

15. The sanitary hose as claimed in claim 1, wherein the antimicrobial agent comprises particles.

16. The sanitary hose as claimed in claim 1, wherein the at least one antimicrobial agent comprises at least one of a metal and a metal salt.

17. The sanitary hose as claimed in claim 1, wherein the at least one antimicrobial agent comprises a non-specific organic antimicrobial agent.

18. The sanitary hose as claimed in claim 1, wherein the antimicrobial agent comprises a mixture of at least two agents.

19. The sanitary hose as claimed in claim 1, wherein the agent is present in at least one of the inner surface and the outer surface, in a concentration ranging from 0.01 to 10% by weight.

20. The sanitary hose as claimed in claim 1, wherein the antimicrobial agent comprises particles having a particle size in the range from 5 μm to 200 μm.

21. The sanitary hose as claimed in claim 16, wherein the at least one of the metal and the metal salt comprises silver.

22. The sanitary hose as claimed in claim 1, wherein the agent is present in at least one of an inner surface layer and an outer surface layer, in a concentration ranging from 0.01 to 10% by weight.

23. The sanitary hose as claimed in claim 19, wherein the concentration of the agent ranges from 0.1 to 2% by weight.
